(19) United States
(12) Patent Application Publication
(10) Pub. No.: US 2025/0329084 A1
(43) Pub. Date: Oct. 23, 2025

(54) IMAGE GENERATION USING VISUAL LANGUAGE MODELS AND/OR OTHER GENERATIVE MODEL(S)

(71) Applicant: GOOGLE LLC, Mountain View, CA (US)

(72) Inventors: Ágoston Weisz, Zurich (CH); Michael Andrew Goodman, Oakland, CA (US)

(21) Appl. No.: 18/643,512

(22) Filed: Apr. 23, 2024

(51) Int. Cl. G06T 11/60; G06F 40/40; G06N 3/092; G06T 9/00

(52) U.S. Cl. CPC G06T 11/60; G06F 40/40; G06N 3/092; G06T 9/00

(57) ABSTRACT

Implementations relate to generating multi-modal response(s) through utilization of generative model(s), such as large language model(s) LLM(s)), visual language model(s), multi-modal language model(s), and/or other generative model(s). Processor(s) of a system can: obtain an input image; obtain an input prompt comprising instructions for modifying the input image; generate an encoding of the input image using an image encoder; modify the encoding of the input image based upon the input prompt using a visual language model; and generate an output image based upon the modified encoding of the input image.

### BACKGROUND

Large language models (LLMs) are powerful machine learning models that can be used to perform a diverse set of tasks. LLMs are typically trained on enormous amounts of diverse data including data from, but not limited to, webpages, electronic books, software code, electronic news articles, and machine translation data. Accordingly, these LLMs leverage the underlying data on which they were trained in performing these various natural language processing (NLP) tasks. For instance, in performing a language generation task, these LLMs can process a natural language (NL) based input that is received from a client device and generate a response that is responsive to the NL based input and that is to be rendered at the client device.

LLMs have been extended to model other modalities including visual inputs such as image and video data. Referred to hereinafter, as visual language models (VLMs) (also known as vision-language models or multi-modal language models), VLMs augment the natural language understanding power of LLMs with visual input understanding. A VLM can process a multi-modal input including an NL input and a visual input and can, for example, perform reasoning regarding what is depicted in the visual input for a variety of NL and visual based tasks.

In one example task, a VLM can generate an image according to instructions specified by a user in an NL input. However, describing an image precisely using natural language can be difficult for a user. The user may have to iteratively refine the NL input depending on the resulting generated image. As a result, a greater amount of computational resources may have to be consumed due to repeated interactions with the VLM system as the user attempts to guide the VLM towards generating a desired image. Thus, there is a need for improved image generation for VLMs.

### SUMMARY

Implementations described herein relate to generating images using a generative model (GM), such as a large language model LLM, a visual language model, a multi-modal generative model, etc. The generated images can also be frames of a video. Processor(s) of a system can: obtain an input image and an input prompt comprising instructions for modifying the input image, generate an encoding of the input image using an image encoder, modify the encoding of the input image based upon the input prompt using a visual language model, and generate an output image based upon the modified encoding of the input image. That is, the output image can be a modified version of the input image that is modified based on the input prompt.

Typically, when attempting to generate an image using an image generation system, a user will have an image in mind. Describing the image precisely in natural language (NL) may be difficult for the user, particularly if the image has high complexity or if the image contains novel elements. As such, any image generated by the GM may not be what the user desired. Rather than describing the image fully from scratch in NL, it could be easier for the user to provide a starting image and to specify how that starting image should be modified to generate the final image. For example, the user can draw an initial sketch or can provide an existing image as a starting point. The modifications can include, for instance, changing colors, textures, styles, sizes, positions, orientations of objects or elements in the image, or adding and removing objects and elements. For example, a user may be interested in re-modelling their kitchen and generating an image of their ideal kitchen. The user may take an image of a kitchen from a magazine to serve as a basis and specify their desired changes, such as, “I would like the counter-tops to have a marble look,” or “please swap the positions of the refrigerator and the cooker.” In another example, the user may be interested in generating an image of a novel fantasy creature. Describing the exact shape of the creature may be difficult and as such, the user may provide a rough sketch of the creature supplemented with a description of the specific details of the creature, for example, “the skin is green and scaly” or “the beak is purple” or “the claws are sharp and red.”

The starting image and modification instructions are provided as input to the VLM. An encoding of the input image is generated and the VLM modifies the encoding based upon the instructions for modifying the input image. The encoding of the input image can be an embedding (e.g., a lower-level representation) in a learned embedding space (e.g., a lower-level space) that provides for greater disentanglement of semantic concepts (e.g., due to the lower-level representation of the input image in the learned lower-level space). As such, it can be easier to carry out modifications according to the user's instructions in encoding space rather than in pixel space (e.g., by moving the lower-level representation of the input image in the lower-level space based on the user's instructions). An output image can then be generated using the modified encoding. In some implementations, the GM's native image generation capabilities can be used to generate the output image. Alternatively, the GM can generate an appropriate request to an external image generation system to generate the output image.

In this way, the generated image can be a modified version of the input image based upon the instructions provided by the user. The image understanding and reasoning power of a GM can be leveraged to better understand the user's instructions and to make the corresponding modifications to the encoding to enable generation of a user's desired image. The user is provided with greater control over the image generation process and the generated output images have improved correspondence with the user's intentions. Computational resources can therefore be conserved as the user is less likely to require multiple iterations to generate a desired image. The techniques described herein therefore provide an improved image generation process.

In some implementations, a GM can include at least hundreds of millions of parameters. In some of those implementations, the GM includes at least billions of parameters, such as one hundred billion or more parameters. In some additional or alternative implementations, a GM is a sequence-to-sequence model, is Transformer-based, can include an encoder and/or a decoder, and/or can include attention mechanism(s). One non-limiting example of a GM is GOOGLE'S Gemini family of models. It should be noted that the GMs described herein are not intended to be limiting.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an example process flow of generating images through utilization of visual language model(s) (VLM(s)) using various components from FIG. 1, in accordance with various implementations.

FIG. 3 depicts a flowchart illustrating an example method of fine-tuning a visual language model (VLM) to generate images, in accordance with various implementations.

FIG. 4 depicts a flowchart illustrating an example method of generating images through utilization of visual language model(s) (VLM(s)).

FIG. 5 depicts an example architecture of a computing device, in accordance with various implementations.

### DETAILED DESCRIPTION OF THE DRAWINGS

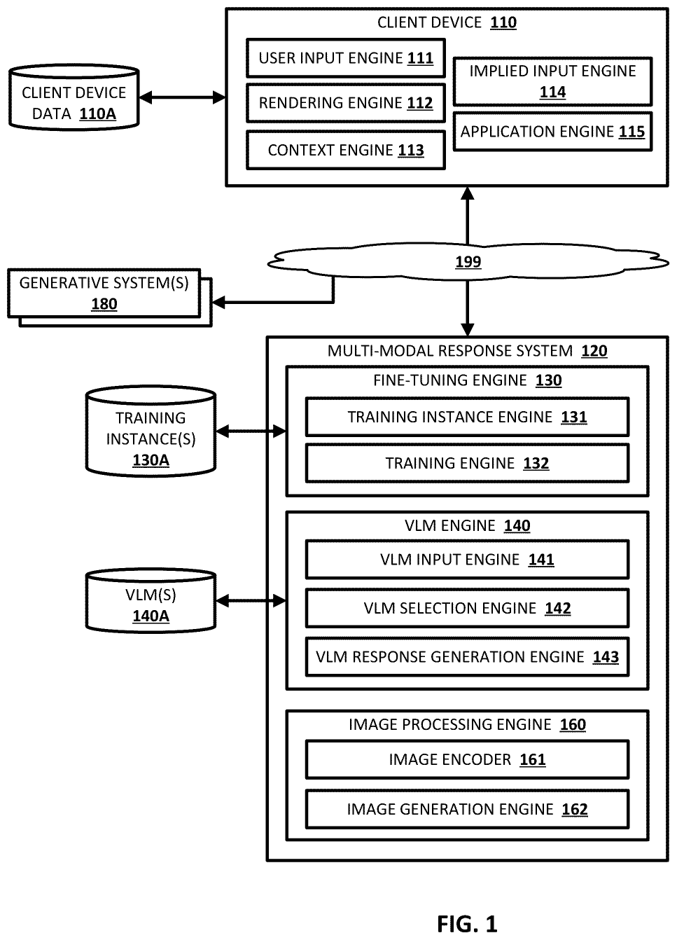

Turning now to FIG. 1, a block diagram of an example environment that demonstrates various aspects of the present disclosure, and in which implementations disclosed herein can be implemented is depicted. The example environment includes a client device 110 and a multi-modal response system 120. In some implementations, all or aspects of the multi-modal response system 120 can be implemented locally at the client device 110. In additional or alternative implementations, all or aspects of the multi-modal response system 120 can be implemented remotely from the client device 110 as depicted in FIG. 1 (e.g., at remote server(s)). In those implementations, the client device 110 and the multi-modal response system 120 can be communicatively coupled with each other via one or more networks 199, such as one or more wired or wireless local area networks (“LANs,” including WI-FI, mesh networks, BLUETOOTH, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which multi-modal input can be submitted and/or multi-modal responses and/or other responses (e.g., uni-modal responses) that are responsive to the multi-modal input can be rendered (e.g., audibly and/or visually). The application engine 115 can execute one or more software applications that are separate from an operating system of the client device 110 (e.g., one installed “on top” of the operating system)-or can alternatively be implemented directly by the operating system of the client device 110. For example, the application engine 115 can execute a web browser or automated assistant installed on top of the operating system of the client device 110. As another example, the application engine 115 can execute a web browser software application or automated assistant software application that is integrated as part of the operating system of the client device 110. The application engine 115 (and the one or more software applications executed by the application engine 115) can interact with or otherwise provide access to (e.g., as a frontend) the multi-modal response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110.

Some instances of an input prompt described herein can be provided by a user of the client device 110 and detected via user input engine 111. For example, the input prompt can be typed via a physical or virtual keyboard, be a suggestion displayed by the client device 110 that is selected via a touch screen or a mouse of the client device 110, be speech that is detected via microphone(s) of the client device 110 (and optionally directed to an automated assistant executing at least in part at the client device 110). An image input or video input can be based on vision data captured by vision component(s) of the client device 110 or be obtained from an application such as a web browser or photograph collection.

In various implementations, the client device 110 can include a rendering engine 112 that is configured to render content (e.g., uni-modal responses, multi-modal responses, an indication of source(s) associated with portion(s) of the uni-modal and/or multi-modal responses, and/or other content) for audible and/or visual presentation to a user of the client device 110 using one or more user interface output devices. For example, the client device 110 can be equipped with one or more speakers that enable audible content to be provided for audible presentation to the user via the client device 110. Additionally, or alternatively, the client device 110 can be equipped with a display or projector that enables textual content or other visual content (e.g., image(s), video(s), etc.) to be provided for visual presentation to the user via the client device 110.

In various implementations, the client device 110 can include a context engine 113 that is configured to determine a client device context (e.g., current or recent context) of the client device 110 and/or a user context of a user of the client device 110 (or an active user of the client device 110 when the client device 110 is associated with multiple users). In some of those implementations, the context engine 113 can determine a context based on data stored in client device data database 110A. The data stored in the client device data database 110A can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, user profile data that characterizes a profile of a user of the client device 110, and/or any other data accessible to the context engine 113 via the client device data database 110A or otherwise.

For example, the context engine 113 can determine a current context based on a current state of a dialog session (e.g., considering one or more recent inputs provided by a user during the dialog session), profile data, and/or a current location of the client device 110. For instance, the context engine 113 can determine a current context of “visitor looking for upcoming events in Louisville, Kentucky” based on a recently issued query, profile data, and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting an input prompt that is formulated based on user input, in generating an implied input prompt (e.g., an implied query or prompt formulated independent of any explicit input prompt provided by a user of the client device 110), and/or in determining to submit an implied input prompt and/or to render result(s) (e.g., a response) for an implied input prompt.

In various implementations, the client device 110 can include an implied input engine 114 that is configured to: generate an implied input prompt independent of any user explicit input prompt provided by a user of the client device 110; submit an implied input prompt, optionally independent of any user explicit input prompt that requests submission of the implied input prompt; and/or cause rendering of search result(s) or a response for the implied input prompt, optionally independent of any explicit input prompt that requests rendering of the search result(s) or the response. For example, the implied input engine 114 can use one or more past or current contexts, from the context engine 113, in generating an implied input prompt, determining to submit the implied input prompt, and/or in determining to cause rendering of search result(s) or a response that is responsive to the implied input prompt. For instance, the implied input engine 114 can automatically generate and automatically submit an implied query or implied prompt based on the one or more past or current contexts. Further, the implied input engine 114 can automatically push the search result(s) or the response that is generated responsive to the implied query or implied prompt to cause them to be automatically rendered or can automatically push a notification of the search result(s) or the response, such as a selectable notification that, when selected, causes rendering of the search result(s) or the response. Additionally, or alternatively, the implied input engine 114 can submit respective implied input prompt at regular or non-regular intervals, and cause respective search result(s) or respective responses to be automatically provided (or a notification thereof automatically provided). For instance, the implied input prompt can be “patent news” based on the one or more past or current contexts indicating a user's general interest in patents, the implied input prompt or a variation thereof periodically submitted, and the respective search result(s) or the respective responses can be automatically provided (or a notification thereof automatically provided). It is noted that the respective search result(s) or the response can vary over time in view of, e.g., presence of new/fresh search result document(s) over time.

Further, the client device 110 and/or the multi-modal response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The multi-modal response system 120 is illustrated in FIG. 1 as including a fine-tuning engine 130, a visual language model (VLM) engine 140, and an image processing engine 160. Some of these engines can be combined and/or omitted in various implementations. Further, these engines can include various sub-engines. For instance, the fine-tuning engine 130 is illustrated in FIG. 1 as including a training instance engine 131 and a training engine 132.

The training instance engine 131 can select training instances, for example, from training instance(s) database 130A, for training a VLM. In some implementations, the training instance engine 131 can also generate training instances based on data that is accessible to the training instance engine 131 via the training instance(s) database 130A.

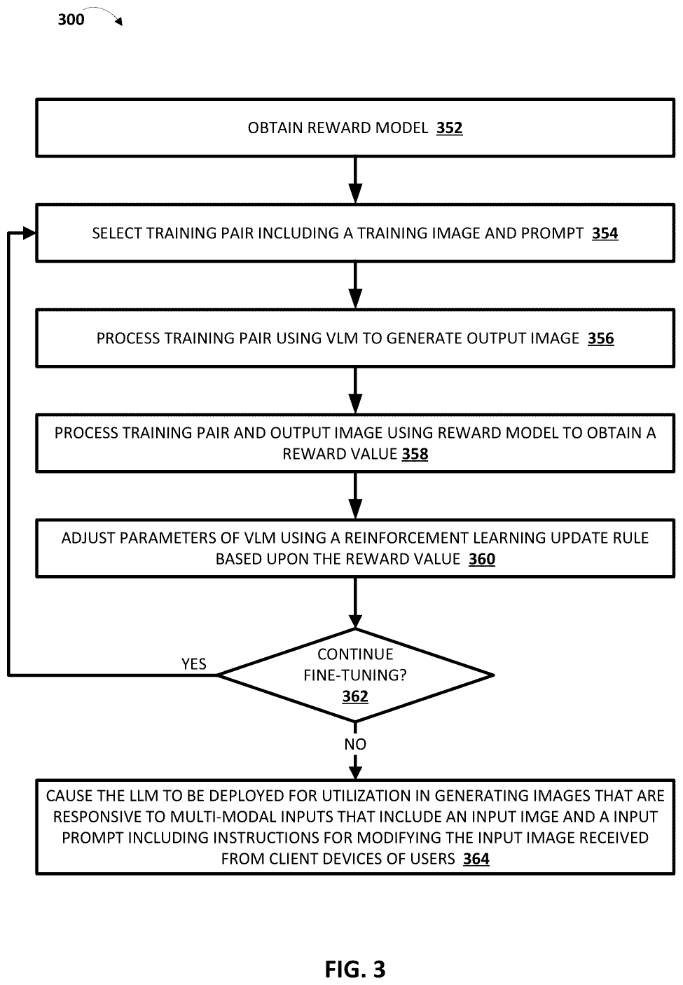

The training engine 132 can train one or more VLMs using the selected training instances. For example, the training engine 132 can fine-tune the parameters of one or more VLMs stored in a VLM database 140A to carry out a specific task. In various implementations, the training engine 132 can perform all or aspects of method 300 of FIG. 3.

Further, the VLM engine 140 illustrated in FIG. 1 includes a VLM input engine 141, a VLM selection engine 142, and a VLM response generation engine 143.

The VLM input engine 141 can, in response to receiving an input from the client device 110, carry out pre-processing of the user input to generate VLM input for processing by a VLM or other engines/sub-engines. For example, the VLM input engine 141 can determine whether multiple modalities are present in the user input, such as an input image and a text input prompt and can separate the user input by modality for subsequent processing. For example, the VLM input engine 141 can provide the input image to the image processing engine 160 for further processing as described below. The VLM input engine 141 can further process the text input prompt, if necessary. For example, the text input prompt can be tokenized to generate VLM input or the VLM input engine 141 can provide the text input prompt to a separate text encoder (not shown in FIG. 1) to carry out tokenization.

The VLM selection engine 142 can, in response to receiving an input (e.g., a raw user input or VLM input), determine which, if any, of multiple generative model(s) (VLM(s) and/or other generative model(s)) to utilize in generating response(s) to render responsive to the input. For example, the VLM selection engine 142 can select one, or multiple generative model(s) to utilize in generating response(s) to render responsive to an input. The VLM selection engine 142 can optionally utilize one or more classifiers and/or rules (not illustrated).

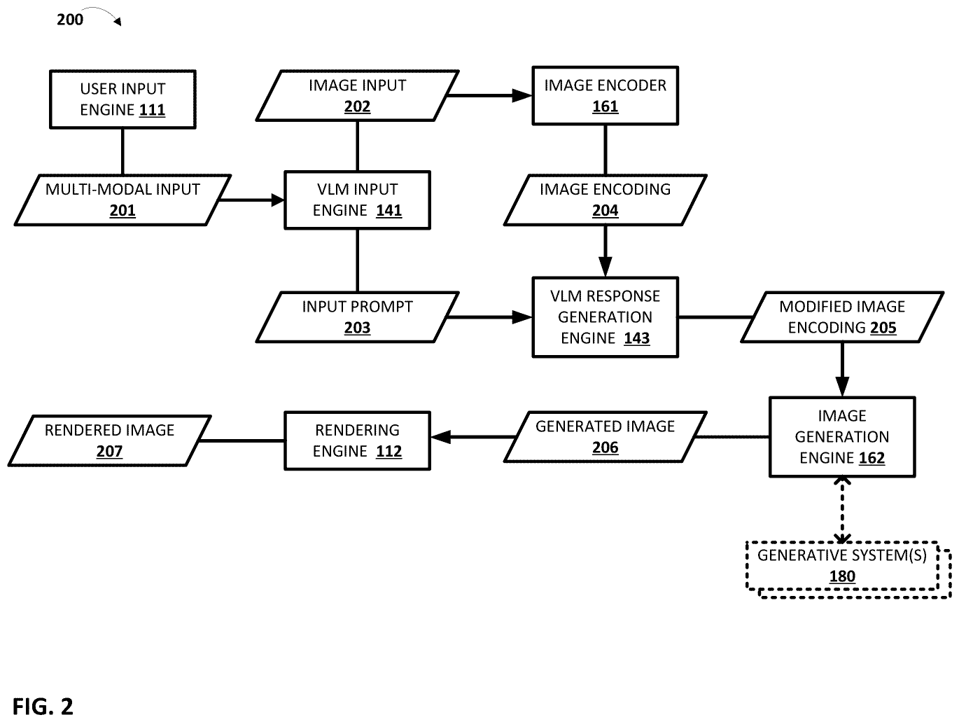

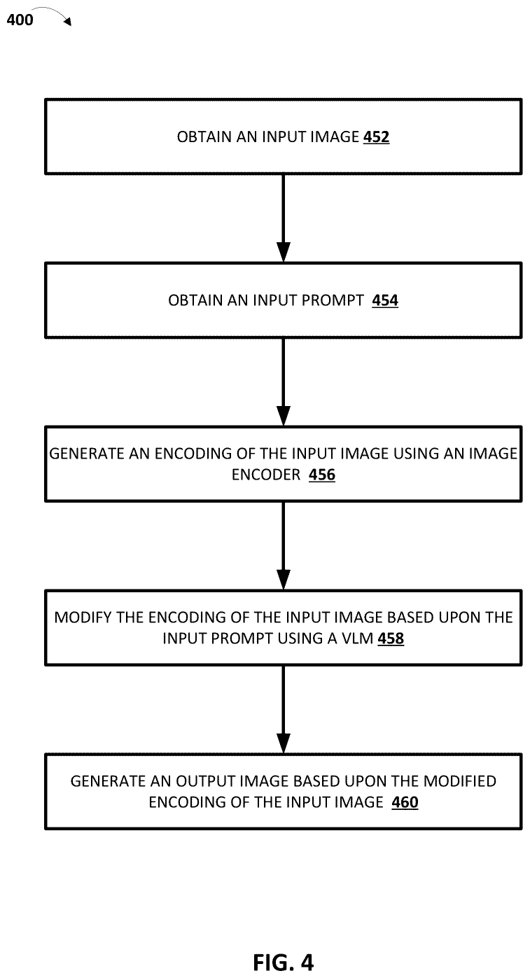

The VLM response generation engine 143 can process the VLM input that is generated by the VLM input engine 141 using a VLM (e.g., stored in VLM(s) database 140A) to generate a response. The response can be a multi-modal response, for example, including both an image output and natural language (NL) text output, or a uni-modal response as determined by the VLM. In various implementations, the VLM response generation engine 143 can be used as indicated in FIG. 2, perform all or aspects of block 356 of method 300 of FIG. 3 and/or block 458 of method 400 of FIG. 4. Although the multi-modal response system 120 is depicted as including the VLM engine 140 and the various sub-engines, it should be understood that is for the sake of example and that any generative model(s) capable of performing image and/or video understanding may be utilized.

Further, the image processing engine 160 illustrated in FIG. 1 includes an image encoder 161 and an image generation engine 162. The image encoder 161 can generate an encoding of image as described in more detail below. In various implementations, the image encoder can be used as indicated in FIG. 2, perform aspects of block 356 of method 300 of FIG. 3, and/or perform all or aspects of block 456 of method 400 of FIG. 4.

The image generation engine 162 can generate an image in response to an input. In some implementations, the image generation engine 162 uses a VLM (e.g., stored in the VLM(s) database 140A) to generate an image. In other implementations, the image generation engine 162 interfaces with an external generative system 180 to generate an image. In further implementations, the image generation engine 162 can use an internal image generation model separate to a VLM. In some implementations, the VLM response generation engine 143 can provide an indication of the image generation system to use.

The image generation engine 162 can condition image generation based upon the processing carried out by a VLM. For example, an image can be generated based upon a modified image encoding generated by a VLM (or other generative model that is capable of performing image and/or video understanding) as described in more detail below. In various implementations, the image generation engine 162 can be used as indicated in FIG. 2, perform aspects of block 356 of method 300 of FIG. 3, and/or perform all or aspects of block 460 of method 400 of FIG. 4.

It will be appreciated that some of the sub-engines illustrated in FIG. 1 can be combined and/or omitted in various implementations. Accordingly, it should be understood that the various engines and sub-engines of the multi-modal response system 120 illustrated in FIG. 1 are depicted for the sake of describing certain functionalities and is not meant to be limiting.

Further, the multi-modal response system 120 illustrated in FIG. 1 can interface with various databases, such as the training instance(s) database 130A and the VLM(s) database 140A as describe above. Although particular engines and/or sub-engines are depicted as having access to particular databases, it should be understood that is for the sake of example and is not meant to be limiting. For instance, in some implementations, each of the various engines and/or sub-engines of the multi-modal response system 120 may have access to each of the various databases. Further, some of these databases can be combined and/or omitted in various implementations. Accordingly, it should be understood that the various databases interfacing with the multi-modal response system 120 illustrated in FIG. 1 are depicted for the sake of describing certain data that is accessible to the multi-modal response system 120 and is not meant to be limiting.

Moreover, the multi-modal response system 120 illustrated in FIG. 1 can interface with other system(s), such as generative system(s) 180. As an example, the generative system(s) 180 can include image generation systems and in some implementations, can interface with the image generation engine 162 to provide (additional) image generation functionality. In some implementations, the generative system(s) 180 are first-party system(s), whereas in other implementations, the generative system(s) 180 are third-party system(s). As used herein, the term “first-party” refers to an entity that develops and/or maintains the multi-modal response system 120, whereas the term “third-party” or “third-party entity” refers to an entity that is distinct from the entity that develops and/or maintains the multi-modal response system 120.

As described in more detail herein (e.g., with respect to FIGS. 2, 3, and 4), the multi-modal response system 120 can be utilized to generate images that are modified versions of an input image according to instructions included in an input prompt.

Turning now to FIG. 2, an example process flow 200 of generating images through utilization of visual language model(s) (VLM(s)) using various components from FIG. 1 is depicted. The user input engine 111 of a client device 110 receives multi-modal input 201. The multi-modal input 201 includes an input image and an input prompt. The input image can be a photograph captured by a camera of the client device 110. In some implementations, the client device 110 can enable the user to create a drawing using a particular application on the client device 110. In additional or alternative implementations, the user can provide a link at which an image can be obtained, either locally on the client device 110 or via network 199. The input image can be represented as, for example, pixel values.

The input prompt includes instructions for modifying the input image and can be in the form of natural language (NL) text. The input prompt can be typed by a user at the client device 110 or the input prompt can be an automatically generated transcription of speech spoken by a user captured by a microphone of the client device 110. The instructions for modifying the input image can be specific, such as, “Please change the color of the car to red,” or the instructions can be more general, such as, “Please make the landscape look like Mars.”

The multi-modal input 201 is received by VLM input engine 141 of the multi-modal response system 120. In some implementations, the multi-modal response system 120 is remote from the client device 110 and the multi-modal input 201 is transmitted from the client device 110 to the multi-modal response system 120 over network 199. In other implementations, the multi-model response system 120 resides on the client device 110 and the multi-modal input 201 can be retrieved from a memory or storage of the client device 110.

The VLM input engine 141 can separate the multi-modal input 201 according to their respective modalities to extract the input image 202 and input prompt 203. An image encoder 161 can then process the input image 202 to generate an encoding of the input image 204. Generally, the encoding 204 of the input image is in a learned latent space that provides for better disentanglement of semantic concepts as compared to pixel space. The image encoder 161 can take any suitable form and can for example, be based upon a Vision Transformer. The image encoder 161 can be pre-trained on a large amount image data using unsupervised or self-supervised learning techniques and can be fine-tuned as discussed below. In some implementations, the image encoder 161 is part of the VLM (or other generative model).

The encoding 204 of the input image can take any suitable form. For example, the encoding 204 can be a sequence of visual tokens. These can be output by a final layer of a Vision Transformer for example. Each visual token can be an embedding in a continuous latent space or can be an embedding selected from a discrete codebook/vocabulary. The visual tokens can correspond to spatial positions or patches of the input image 202. In another example, the encoding 204 can be based upon the result of one or more pooling operations over the output of one or more layers of the image encoder 161 or the concatenation of one or more such outputs. Thus, the encoding 204 can be considered as a single embedding vector or a sequence/plurality of embedding vectors. In some implementations, the encoding 204 can also include positional embeddings associated with each token.

The VLM response generation engine 143 processes the encoding 204 of the input image and the input prompt 203 using a VLM to generate a modified encoding 205. In some implementations, the input prompt 203 can undergo pre-processing operations prior to processing by the VLM. For example, the input prompt 203 can be tokenized using a text encoder.

The VLM can have any appropriate architecture. For example, the VLM can include one or more Transformer blocks and can have an encoder/decoder, encoder-only or decoder-only architecture. In some implementations, the one or more Transformer blocks includes a cross-attention operation. The cross-attention operation can have a first cross-attention input based upon the encoding 204 of the input image and a second cross-attention input based upon the input prompt 203. The cross-attention operation can therefore be considered to update or modify the encoding 204 of the input image by attending to the input prompt 203. It will be appreciated, however, that the encoding 204 of the input image and the input prompt 203 can be processed by one or more neural network layers prior to the cross-attention operation and successive cross-attention operations can be applied with further cross-attention Transformer blocks to successively update the encoding 204 of the input image.

In another example, the encoding 204 of the input image and an encoding of the input prompt 203 can be concatenated and provided as input to the VLM. The VLM can include one or more Transformer blocks with a self-attention operation. The self-attention operation can enable the VLM to focus on the most relevant parts of the encoding 204 of the input image in accordance with the instructions in the input prompt 203 and to update the encoding 204 of the input image as appropriate. As with the cross-attention operation, the encoding 204 of the input image and the input prompt 203 can be processed by one or more neural network layers prior to the self-attention operation and successive self-attention operations can be applied with further self-attention Transformer blocks to successively update the encoding 204 of the input image.

In some implementations, the VLM can include a combination of cross-attention and self-attention operations. In these implementations, the input to the self-attention operation can be based on the encoding 204 of the input image without concatenation with the input prompt 203 (or a derivative) as attention to the input prompt 203 can be provided via cross-attention. It will be appreciated that in any Transformer-based implementation, the cross-attention and/or self-attention operation may be multi-headed.

In a further example, one or more projection neural network layers can be used to project the encoding 204 of the input image and an encoding of the input prompt 203 into the same latent space which can then be processed by the VLM.

As discussed above, the VLM (or other generative model) can include a plurality of Transformer blocks and each Transformer block can successively update the encoding 204 of the input image. The final Transformer block (or final neural network layer) of the VLM can provide the final modified encoding 205. The final modified encoding 205 can be generated either autoregressively or non-autoregressively as appropriate. Where the encoding is based upon a discrete codebook/vocabulary, updating the encoding can include selecting a different embedding from the codebook/vocabulary. In some implementations, the VLM can provide a probability distribution over possible values for each element of the encoding and the probability distribution can be sampled to generate an updated value.

The image generation engine 162 uses the modified encoding 205 provided by the VLM to generate an output image 206. In some implementations, the VLM has native image generation capabilities and the VLM can be used to generate an output image from the modified encoding 205. In other implementations, the modified encoding 205 can be decoded using an image decoder corresponding to the image encoder 204 to generate an output image 206. Alternatively, in further implementations, the image generation engine 162 can interface with an external image generation system 180 to generate an image based upon the modified encoding 205, for example, by conditioning image generation on the modified encoding 205.

The generated output image 206 is a modified version of the input image 202, modified according to the instructions in the input prompt 203. The generated output image 206 is provided to the client device 110 and a rendering engine 112 can render the output image 207. In some implementations, the VLM response engine 143 also provides additional NL text output to be displayed with the generated output image 206. For example, NL text output can provide reasoning, or an explanation of the modifications made to the input image 202.

Should the user desire to make further modifications to the output image, the user can provide a second prompt including instructions for modifying the output image. The process can therefore be repeated using the second prompt as the new input prompt and the output image as the new input image. If the output image and its encoding has been stored at the multi-modal response system 120, the client device 110 can avoid re-transmitting the output image and processing the output image with the image encoder 161 can be avoided.

The encoding of the output image is modified in accordance with the instructions in the second prompt and the modified encoding is used to generate a new output image. The new output image is therefore a modified version of the first output image 206 that is modified based on the second input prompt. This in turn can be considered to be a modification of the original input image based upon the second prompt.

By operating on image encodings, the system enables the user able to iteratively edit a generated image, keeping elements of the generated image that are desirable and editing elements that are less desirable. By comparison, in some prior art systems, the generation of the new output image has no link or is only weakly linked to the first output image. The new image could therefore replace elements that the user did not want to modify and could introduce undesirable changes.

Some image generation systems are unable to accept an encoding of an image as an input and can only accept a text-based prompt. In these cases, instead of using a VLM (or other generative model) to modify an encoding of the input image. The VLM (or other generative model) can generate a prompt that includes NL instructions for a text-to-image machine learning model to generate an output image that would be a result of modifying the input image based upon the modification instructions. As discussed above, users can have difficulty in precisely specifying NL prompts for text-to-image generation systems. The VLM's image understanding, natural language understanding, and natural language generation capabilities can be leveraged to generate an appropriate prompt as input to text-to-image generation system for the user.

A VLM can be fine-tuned (trained) to carry out the above-described image generation techniques using, for example, a Reinforcement Learning with Human Feedback (RLHF) based training method.

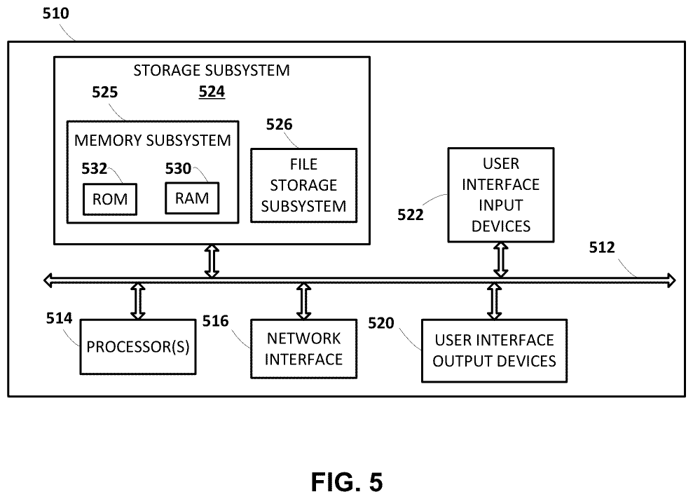

Turning now to FIG. 3, a flowchart illustrating an example method 300 for fine-tuning a VLM using RLHF is depicted. For convenience, the operations of the method 300 are described with reference to a system that performs the operations. This system of the method 300 includes one or more processors, memory, and/or other component(s) of computing device(s) (e.g., client device 110 of FIG. 1, multi-modal response system 120 of FIG. 1, computing device 510 of FIG. 5, one or more servers, and/or other computing devices). For example, the operations of the method 300 can be carried out by the fine-tuning engine 130. Moreover, while operations of the method 300 are shown in a particular order, this is not meant to be limiting. One or more operations may be reordered, omitted, and/or added.

At block 352, the system obtains a reward model. The reward model can be trained on human preference data in order to provide a predicted preference value for a given input. For example, a dataset including a plurality of instances of input pairs can be obtained or generated. Each input pair includes an image and a corresponding prompt including instructions for modifying the image. An input pair can be provided to a plurality of VLMs to each generate an output image, for example, by using the techniques described above. The plurality of VLMs can be a copy of a single VLM but with different parameters, for example, obtained at different checkpoints during pre-training of the VLM. Alternatively, the plurality of VLMs can be unrelated so long as different output images can be generated for an input pair. The plurality of VLMs may be obtained from the VLM database 140A.

One or more human assessors are then asked to rank the plurality of output images in terms of how well the output images match the instructions for modifying the input image. This can be repeated for a plurality of input pairs to obtain a preference dataset. A reward model can then be trained on the preference dataset to provide predicted preferences for new input pairs. The reward model provides a scalar value (the “reward”) as an output can be initialized from a pre-trained VLM or can have its own specific architecture.

At block 354, a training pair is selected. The training pair includes an image and a prompt comprising instructions for modifying the image. The training pair can be selected from the database of training instances 130A for example. The training pair can be a pair that was previously used in training the reward model or can be a pair that has not been previously used.

At block 356, the training pair is processed by the VLM undergoing fine-tuning to generate an output image using the techniques described above. That is, an encoding of the training image is generated and then modified using the VLM based upon the training prompt. An output image is generated based upon the modified encoding to provide a modified version of the training image.

At block 358, the training pair and the output image are processed by the reward model to obtain a reward value. At block 360, the parameters of the VLM undergoing fine-tuning are adjusted using a reinforcement learning update rule based upon the reward value obtained at block 356. For example, the reinforcement learning update rule can be based upon the Proximal Policy Optimization (PPO) algorithm with the VLM undergoing fine-tuning serving as the “policy”. It will be appreciated that other suitable reinforcement learning algorithms can be used as deemed appropriate by a person skilled in the art. In some implementations, a batch of training pairs can be processed in order to determine the update to the VLM parameters. Thus, blocks 354 to 358 can be repeated before proceeding to block 360.

At block 362, the system determines whether to continue fine-tuning the VLM. The system can determine to continue fine-tuning the VLM until one or more conditions are satisfied. The one or more conditions can include, for example, whether the VLM has been fine-tuned based on a threshold quantity of training pairs, whether a threshold duration of time has passed since the fine-tuning process began, whether performance of the VLM has achieved a threshold level of performance, and/or other conditions.

If, at an iteration of block 362, the system determines to continue fine-tuning the VLM, then the system returns to block 354 and repeats blocks 354 to 362. The system can continue fine-tuning the VLM in this manner until the one or more conditions are satisfied at subsequent iterations of block 362.

If, at an iteration of block 362, the system determines not to continue fine-tuning the VLM, then the system proceeds to block 364. At block 364, the system causes the VLM to be deployed for utilization in generating images that are responsive to multi-modal inputs including an input image and a prompt including instructions for modifying the input image received from client devices of users (e.g., as described with respect to FIG. 4).

In some implementations, the VLM and the image encoder are trained jointly. That is, at block 360, both the parameters of the VLM and the image encoder are updated. In other implementations, the image encoder is pre-trained and frozen during the fine-tuning of the VLM. Similarly, the image generation system can be trained jointly with the VLM and/or image encoder or the image generation system can remain unchanged.

As discussed above, the VLM can be pre-trained. In general, a VLM can be pre-trained on large amounts of data including data from, but not limited to, webpages, electronic books, software code, electronic news articles, and machine translation data. In some implementations, the VLM can be trained on uni-modal data and multi-modal data. For example, the image processing components of the VLM can be trained on image data only to learn a good initial representation of images. Similarly, the text processing components of the VLM can be trained on text data only to learn a good initial representation of text and language. Unsupervised or self-supervised learning can be used for this representation learning. For example, a next token prediction task and/or a masked token prediction task can be used. For multi-modal training, the VLM can be trained using corresponding image and text pairs. For example, these can be obtained from alt-text for images on webpages. Next token prediction and masked token prediction can also be used for multi-modal training. For example, the task can involve prediction of a caption for a particular image. Other tasks can include a matching task, for example, determining whether a particular text caption matches a particular image or vice versa.

Following pre-training, a VLM may undergo further training to improve the VLM's ability to respond to user prompts and queries. For example, supervised fine-tuning (SFT) and/or RLHF can be used. In SFT, a high-quality dataset including examples of input prompts and corresponding responses (which may be multi-modal) can be used. This data is typically generated by human annotators, though this data can be augmented by using the models themselves to generate further examples using human annotated data as seeds. The VLM is trained using supervised learning to generate the corresponding responses from the input prompt. The VLM can also be trained using RLHF similar to the process described above. That is, a reward model can be trained from human preference data regarding different outputs generated from the same input prompt and RL used to update the parameters of the VLM based upon the reward values provided by the trained reward model.

It will be appreciated that the training described above in FIG. 3 is not limited to any particular VLM having undergone any particular form of pre-training or subsequent training. Rather, it should understood that such RLHF and/or SFT training techniques can be utilized to train any VLM or other generative model.

Turning now to FIG. 4, a flowchart illustrating an example method 400 of generating images utilizing VLMs is depicted. For convenience, the operations of the method 400 are described with reference to a system that performs the operations. This system of the method 400 includes one or more processors, memory, and/or other component(s) of computing device(s) (e.g., client device 110 of FIG. 1, multi-modal response system 120 of FIG. 1, computing device 510 of FIG. 5, one or more servers, and/or other computing devices). Moreover, while operations of the method 400 are shown in a particular order, this is not meant to be limiting. One or more operations may be reordered, omitted, and/or added.

At block 452, the system obtains an input image. The input image can be received from a user (client) device and is an image that the user wishes to use as a starting point for generating a final image. The input image can be any type of image. For example, the input image can be a photograph captured by a camera of the user device. In some implementations, the user device can enable a user to create a drawing. As another example, the user may provide a link to an image and the system can retrieve the image from the link.

At block 454, the system obtains an input prompt comprising instructions for modifying the input image. The input prompt can be received from the user device. The input prompt can be in natural language and can be typed by a user of the user device or can be an automatically generated transcription of speech spoken by the user captured by a microphone of the user device. The instructions for modifying the input image can be specific with reference to particular objects depicted in the image, for example, “Please change the color of the car to red,” or the instructions can be more general such as, “Please make the landscape look like Mars.”

It will be appreciated that the input image and input prompt can be transmitted together from the user device, or the input image and input prompt can be transmitted from the user device separately.

At block 456, the system generates an encoding of the input image using an image encoder. The image encoder can be take any suitable form and can for example, be based upon a Vision Transformer. The image encoder can be pre-trained on a large amount image data using unsupervised or self-supervised learning techniques and can be fine-tuned as discussed above in relation to FIG. 3. In some implementations, the image encoder is part of the VLM.

The encoding of the input image can take any suitable form. For example, the encoding can be a sequence of visual tokens. These can be output by a final layer of a Vision Transformer for example. Each visual token can be an embedding in a continuous latent space or can be an embedding selected from a discrete codebook/vocabulary. The visual tokens can correspond to spatial positions or patches of the input image. In another example, the encoding can be based upon the result of one or more pooling operations over the output of one or more layers of the image encoder or the concatenation of one or more such outputs. Thus, the encoding can be considered as a single embedding vector or a sequence/plurality of embedding vectors. In some implementations, the encoding can also include positional embeddings associated with each token.

At block 458, the system modifies the encoding of the input image based upon the input prompt using a VLM. In some implementations, the input prompt can undergo pre-processing operations prior to processing by the VLM. For example, the input prompt can be tokenized using a text encoder.

The VLM can have any appropriate architecture. For example, the VLM can include one or more Transformer blocks and can have an encoder/decoder, encoder-only or decoder-only architecture. In some implementations, the one or more Transformer blocks includes a cross-attention operation. The cross-attention operation can have a first cross-attention input based upon the encoding of the input image and a second cross-attention input based upon the input prompt. The cross-attention operation can therefore be considered to update or modify the encoding of the input image by attending to the input prompt. It will be appreciated however that the encoding of the input image and the input prompt can be processed by one or more neural network layers prior to the cross-attention operation and successive cross-attention operations can be applied with further cross-attention Transformer blocks to successively update the encoding of the input image.

In another example, the encoding of the input image and an encoding of the input prompt can be concatenated and provided as input to the VLM. The VLM can include one or more Transformer blocks with a self-attention operation. The self-attention operation can enable the VLM to focus on the most relevant parts of the encoding of the input image in accordance with the instructions in the input prompt and to update the encoding of the input image as appropriate. As with the cross-attention operation, the encoding of the input image and the input prompt can be processed by one or more neural network layers prior to the self-attention operation and successive self-attention operations can be applied with further self-attention Transformer blocks to successively update the encoding of the input image.

In some implementations, the VLM can include a combination of cross-attention and self-attention operations. In these implementations, the input to the self-attention operation can be based on the encoding of the input image without concatenation with the input prompt (or a derivative) as attention to the input prompt can be provided via cross-attention. It will be appreciated that in any Transformer-based implementation, the cross-attention and/or self-attention operation may be multi-headed.

In a further example, one or more projection neural network layers can be used to project the encoding of the input image and an encoding of the input prompt into the same latent space which can then be processed by the VLM.

As discussed above, the VLM can include a plurality of Transformer blocks and each Transformer block can successively update the encoding of the input image. The final Transformer block (or final neural network layer) of the VLM can provide the final modified encoding. The final modified encoding can be generated either autoregressively or non-autoregressively as appropriate. Where the encoding is based upon a discrete codebook/vocabulary, updating the encoding can include selecting a different embedding from the codebook/vocabulary. In some implementations, the VLM can provide a probability distribution over possible values for each element of the encoding and the probability distribution can be sampled to generate an updated value.

At block 460, the system generates an output image based upon the modified encoding of the input image. The output image is a modified version of the input image that is modified based on the input prompt. In some implementations, the VLM has native image generation capabilities and the VLM can be used to generate an output image from the modified encoding. In other implementations, the modified encoding can be decoded using an image decoder corresponding to the image encoder to generate an output image.

Alternatively, in further implementations, an external image generation system can be used to generate an image based upon the modified encoding, for example, by conditioning image generation on the modified encoding.

The generated output image can be provided to the user device and displayed by the user device. In some implementations, the VLM can also generate additional NL text output to be displayed with the generated output image. For example, the NL text output can provide reasoning, or an explanation of the modifications made to the input image.

Should the user desire to make further modifications to the output image, the user can provide a second prompt including instructions for modifying the output image. The process 400 can therefore be repeated using the second prompt as a new input prompt and the output image as the new input image. If the system has stored the output image and its encoding, the user device can avoid re-transmitting the output image and system can avoid processing the output image with the image encoder.

The encoding of the output image is modified in accordance with the instruction in the second prompt and the modified encoding is used to generate a new output image. The new output image can therefore be a modified version of the first output image that is modified based on the second input prompt. This in turn can be considered to be a further modification of the original input image based upon the second prompt.

By operating on image encodings, the system enables the user to iteratively edit a generated image, keeping elements of the generated image that are desirable and editing elements that are less desirable. By comparison, in some prior art systems, the generation of the new output image has no link or is only weakly linked to the first output image. The new image could therefore replace elements that the user did not want to modify and could introduce undesirable changes.

Turning now to FIG. 5, a block diagram of an example computing device 510 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIGS. 1 and 2.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: obtaining an input image; obtaining an input prompt comprising instructions for modifying the input image; generating an encoding of the input image using an image encoder; modifying the encoding of the input image based upon the input prompt using a visual language model; and generating an output image based upon the modified encoding of the input image. Notably, the output image can be a modified version of the input image that is modified based on the input prompt.

These and other implementations of technology disclosed herein can optionally include one or more of the following features.

In some implementations, the input image may be received from a user device.

In additional or alternative further versions of those implementations, the input prompt may be received from a user device.

In some further versions of those implementations, the instructions may include instructions in natural language.

In additional or alternative further versions of those implementations, the output image may be generated by the visual language model.

In additional or alternative further versions of those implementations, the output image may be generated by an image generation machine learning model that is separate from the visual language model.

In additional or alternative further versions of those implementations, the visual language model may include one or more Transformer blocks, and modifying the encoding of the input image may include processing a Transformer block input to generate an updated encoding. The Transformer block input may be based upon the encoding of the input image by the one or more Transformer blocks.

In some further versions of those implementations, at least one of the one or more Transformer blocks may include a cross-attention layer configured to carry out a cross-attention operation between a first cross-attention input based upon the encoding of the input image and a second cross-attention input based upon the input prompt.

In additional or alternative versions of those implementations, the method may further include: obtaining a second input prompt comprising instructions for modifying the generated output image; modifying an encoding of the generated output image based upon the second input prompt using the visual language model; and generating a second output image based upon the modified encoding of the generated output image. Notably, the second output image may be a further modified version of the input image that is modified based on the second input prompt.

In additional or alternative versions of those implementations, the visual language model may be trained to modify the encoding of the input image based upon a reinforcement learning with human feedback training technique.

In additional or alternative versions of those implementations, the visual language model and the image encoder may be trained jointly.

In additional or alternative versions of those implementations, the visual language model, the image encoder, and the image generation machine learning model may be trained jointly.

In additional or alternative versions of those implementations, the visual language model may be pre-trained.

In some implementations, a method implemented by one or more processors is provided, and includes: obtaining an input image; obtaining an input prompt comprising instructions for modifying the input image; and generating a second prompt comprising instructions for generating an output image. Generating the second prompt includes processing the input image and the instruction for modifying the input image using a visual language model to generate the second prompt. The method further includes generating the output image using a text-to-image machine learning model based upon the second prompt.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
obtaining an input image;
obtaining an input prompt comprising instructions for modifying the input image;
generating an encoding of the input image using an image encoder;
modifying the encoding of the input image based upon the input prompt using a visual language model; and
generating an output image based upon the modified encoding of the input image.

2. The method of claim 1, wherein the input image is received from a user device.

3. The method of claim 1, wherein the input prompt is received from a user device.

4. The method of claim 1, wherein the instructions comprise instructions in natural language.

5. The method of claim 1, wherein the output image is generated by the visual language model.

6. The method of claim 1, wherein the output image is generated by an image generation machine learning model that is separate from the visual language model.

7. The method of claim 6, wherein the visual language model, the image encoder and the image generation machine learning model are trained jointly.

8. The method of claim 1, wherein the visual language model comprises one or more Transformer blocks, and modifying the encoding of the input image comprises processing a Transformer block input, wherein the Transformer block input is based upon the encoding of the input image, by the one or more Transformer blocks to generate an updated encoding.

9. The method of claim 8, wherein at least one of the one or more Transformer blocks comprises a cross-attention layer configured to carry out a cross-attention operation between a first cross-attention input based upon the encoding of the input image and a second cross-attention input based upon the input prompt.

10. The method of claim 1, further comprising:
obtaining a second input prompt comprising instructions for modifying the generated output image;
modifying an encoding of the generated output image based upon the second input prompt using the visual language model; and
generating a second output image based upon the modified encoding of the generated output image.

11. The method of claim 1, wherein the visual language model is trained to modify the encoding of the input image based upon a reinforcement learning with human feedback training technique.

12. The method of claim 1, wherein the visual language model and the image encoder are trained jointly.

13. The method of claim 1, wherein the visual language model is pre-trained.

14. A system comprising:
one or more processors; and
a memory storing computer readable instructions that, when executed by the one or more processors, cause the one or more processors to:
obtain an input image;
obtain an input prompt comprising instructions for modifying the input image;
generate an encoding of the input image using an image encoder;
modify the encoding of the input image based upon the input prompt using a visual language model; and
generate an output image based upon the modified encoding of the input image.

15. The system of claim 14, wherein the input image is received from a user device.

16. The system of claim 14, wherein the input prompt is received from a user device.

17. The system of claim 14, wherein the instructions comprise instructions in natural language.

18. The system of claim 14, wherein the output image is generated by the visual language model, or wherein the output image is generated by an image generation machine learning model that is separate from the visual language model.

19. The system of claim 14, wherein the instructions further cause the one or more processors to:
obtain a second input prompt comprising instructions for modifying the generated output image;
modify an encoding of the generated output image based upon the second input prompt using the visual language model; and
generate a second output image based upon the modified encoding of the generated output image.

20. A non-transitory computer-readable storage medium storing instructions that, when executed by one or more processors, cause the one or more processors to perform operations, the operations comprising:
obtaining an input image;
obtaining an input prompt comprising instructions for modifying the input image;
generating an encoding of the input image using an image encoder;
modifying the encoding of the input image based upon the input prompt using a visual language model; and
generating an output image based upon the modified encoding of the input image.
